(19) United States
(12) Patent Application Publication
(10) Pub. No.: US 2002/0163570 A1
(43) Pub. Date: Nov. 7, 2002

(54) System and methods for adjusting color gamut based on printer consumable condition

(76) Inventor: Quintin T. Phillips, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/851,038

(22) Filed: May 7, 2001

(51) Int. Cl. B41J 2/435; G01D 15/14

(52) U.S. Cl. 347/224

(57) ABSTRACT

A printer system adjusts the color gamut available for print jobs based on consumable conditions in a print device. When a non-optimal consumable condition is detected, such as an empty toner color, the printer system offers options for managing the non-optimal consumable condition. One option permits a user to select an alternate color scheme and have the print job resubmitted to the print device for printing with the alternate scheme. The alternate color scheme avoids the non-optimal consumable condition by not using the toner color affected by that condition.

### TECHNICAL FIELD

The present invention relates to replaceable printing device components that are consumed during the printing process and, more particularly, to the adjustment of the color gamut of a print device to compensate for the condition of these consumable components.

### BACKGROUND

Most printing devices are equipped with replaceable components having life cycles during which the replaceable components are functional. These components, often referred to as consumables, include toner cartridges, ink cartridges, ribbon cartridges, fusers, photoconductors, drums, transfer belts, and the like. Consumables such as paper, toner and ink are consumed with each printed page because they make up the printed product. Other than paper, toner or ink cartridges are the most commonly replaced consumables. Consumables such as fusers, photoconductors, and transfer drums or belts, are consumed with each page printed due to deterioration, and are not usually replaced as often as toner or ink cartridges.

There are a number of ways printers generally respond to deficient consumable conditions, such as an empty toner cartridge. For example, some printers respond to an empty toner cartridge by notifying the user and rejecting print jobs. This response can occur in the middle of a print job, or it can occur when a print job is initially sent to the printer. Either way, the user is required to fix the deficiency (e.g., locate and install a new toner cartridge) before the printer will accept or complete a print job.

Other printers do not notify the user of a deficient consumable condition, but simply continue printing. The user is left to discover that the print quality has deteriorated to an unacceptable level and that print jobs will need to be repeated. With non-color printers, a low toner level may be tolerable for brief periods because the gradual lightening of the print output may not be immediately unacceptable. Users generally have an opportunity to replace the toner cartridge prior to the print quality becoming unacceptable.

However, with color printers the affect of the depletion of toner is more pronounced. Color printers typically use the four primary toner colors of cyan, magenta, yellow and black, and a depleted toner color often results in unacceptable streaking, fading of colors and/or change of hue. For example, the color green requires a mixture of cyan and yellow toners. Therefore, an expected green background may streak or fade from green to cyan as the yellow toner level runs low. The reduced print quality is thus quite apparent, and the user ordinarily must locate a replacement toner cartridge or forego the print job.

In addition, color printers often use a single all-in-one toner cartridge that contains all four of the primary toner colors. Because the absence of one toner color typically results in unacceptable print quality, a user cannot continue using the remaining color toners in the cartridge, but instead must replace the cartridge. Having to replace the entire cartridge because one toner color is depleted is a waste of the remaining color toners.

Various methods of modifying printer behavior based on consumable conditions have been developed. For example, monitoring devices have been used to detect when a consumable is nearing the end of its life cycle. The devices signal a user prior to the time when a consumable reaches the end of its life cycle so that the user can replace the consumable before the printer begins rejecting print jobs or before the print quality becomes unacceptable.

A specific example is a “toner low” signal from a print device. Upon seeing the “toner low” signal, the user can go about replacing the toner cartridge in a leisurely manner. Monitoring the toner level and notifying the user prior to the complete depletion of the toner, avoids the hassle of having to immediately locate a replacement cartridge in order to resume printing or maintain print quality.

Another method of modifying printer behavior based on the condition of consumables involves the use of memory devices located on the consumable components. For example, toner cartridges can be manufactured with memory integrated into the cartridge. The memory is used to store printer related data that the printer reads to determine certain printing parameters. The data generally includes the number of pages that are expected to be printed during a toner cartridge life cycle. Therefore, the printer can notify the user as to how many pages remain to be printed by the cartridge. Again, this allows the user to replace the toner cartridge in a leisurely manner and avoid having to immediately locate a replacement toner cartridge in order to resume printing or maintain acceptable print quality.

Unfortunately, these prior methods of addressing deficient consumable conditions do not always solve the problems they are intended to solve. For example, although a user knows a toner cartridge may be close to empty because of a “toner low” signal, the temptation to put-off locating a replacement cartridge often results in the user waiting too long to take action. Therefore, toner cartridges frequently end up being completely depleted despite providing “toner low” warning signals. The problem of having to quickly locate a replacement cartridge in order to resume printing or maintain acceptable print quality thus remains.

Furthermore, these prior methods do not address the problem of wasted color toner that results from having to replace all-in-one toner cartridges just because one of the colors is low or depleted.

Accordingly, the need exists for a way to manage consumable conditions that does not result in the termination of a print job or unacceptable print quality in print jobs. In addition, the need exists for a way of utilizing the remaining color toners in an all-in-one color cartridge that has run out of one of the color toners.

### SUMMARY

A printer system adjusts the color gamut available for print jobs based on consumable conditions in a print device. Color gamut, as used throughout this disclosure, refers to the range of colors that is reproducible by a print device.

When a non-optimal consumable condition is detected, such as an empty toner color, adjustment of the color gamut permits continued printing in a reduced feature mode. Instead of stopping a print job or continuing to print with unacceptable print quality, the printer system offers choices for managing the non-optimal consumable condition. For color print devices using all-in-one toner cartridges, the ability to continue printing in a reduced feature mode avoids some of the waste normally associated with having to replace the entire cartridge when only one of the toner colors in the cartridge is depleted.

In a specific implementation, a printer system includes a host computer coupled to a color print device. The host computer includes printer control logic and a display device. The print device includes a consumable component such as a color toner cartridge that is configured with a monitoring device. The monitoring device monitors the condition of the toner cartridge and notifies the host computer in the event of a non-optimal condition (e.g., a low or empty toner cartridge). Therefore, with respect to any print job, the host computer may receive an indicator that the condition of a consumable component is non-optimal.

The printer control logic responds to a non-optimal consumable condition by informing the user that a toner color has been adversely affected by the condition and by visually displaying the print job on the host computer as it will appear in printed form without the affected toner color. Therefore, where a toner color has been exhausted, the print job will be displayed on the host computer without the exhausted color. In addition to displaying the non-optimal print job, the printer control logic presents the user with options for managing the non-optimal consumable condition.

One such option is to have the computer suggest one or more alternate color schemes for the print job that do not include the missing toner color. A user may select an alternate color scheme and have the print job resubmitted to the print device for printing with the alternate scheme. The color gamut available for printing the job is adjusted according to the alternate color scheme by mapping the print job to a look-up table that replaces non-reproducible colors with reproducible colors. Adjusting the color gamut based on an alternate color scheme permits the print job to proceed without being canceled, avoids the unacceptable fading or streaking between colors that occurs when a toner color is low or empty, and forestalls the need to replace the missing toner color. In addition, where all-in-one color toner cartridges are used, the ability to put-off replacing the depleted toner color while maintaining acceptable print quality permits continued use of the remaining toner colors that would otherwise be wasted if the cartridge were replaced.

In addition to alternate color schemes, the printer control logic presents various other options for managing the non-optimal consumable condition. These options include canceling the print job, permitting the print job to print with the non-optimal condition, deactivating the affected toner color before printing the print job, redirecting the print job to an alternate print device, pausing the print process to permit correction of the non-optimal condition, and printing the print job in grayscale.

### BRIEF DESCRIPTION OF THE DRAWINGS

The same reference numbers are used throughout the drawings to reference like components and features.

FIG. 1 illustrates a workstation and a printing device as a suitable system environment in which to adjust a color gamut based on the condition of a consumable component of the printing device.

FIG. 2 is a block diagram illustrating a system such as that in FIG. 1.

FIG. 3 illustrates a printer device which uses various consumable components.

FIG. 4A is a flow diagram illustrating an example method of printing where an alternate color scheme is made available for a print job based on a non-optimal consumable condition.

FIG. 4B is a continuation of the flow diagram of FIG. 4A, illustrating the basic operations taking place when a color gamut is adjusted.

FIG. 5 is a flow diagram illustrating an example method of printing where a color gamut has been adjusted because of a non-optimal consumable condition.

### DETAILED DESCRIPTION

The system and methods described herein relate to managing a printing process based on the condition of consumable components of a color printing device. System users are notified of non-optimal conditions in consumable components and presented with options for how the system may proceed in processing a print job. The options include having the system suggest one or more alternate color schemes that avoid the non-optimal condition while providing the most likely acceptable alternative to a user. If the user accepts an alternate color scheme, the system adjusts the color gamut (the range of colors reproducible by a print device) for the print job accordingly and resubmits the print job to the print device. By selecting an alternate color scheme, the user avoids having the print job canceled or the unacceptable print quality likely to result from the non-optimal consumable condition.

Exemplary System for Adjusting Color Gamut Based on a Consumable Condition

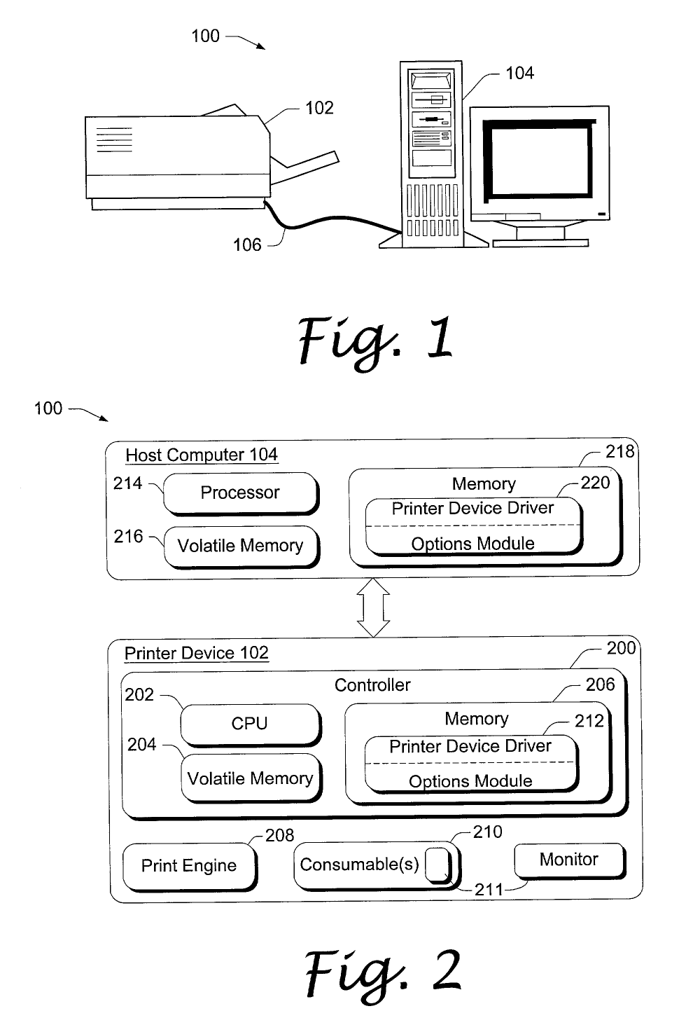

FIG. 1 illustrates an example of a printing system which is suitable for adjusting a color gamut based on the condition of a consumable component of a print device. The system 100 of FIG. 1 includes a printer device 102 connected to a host computer 104 through a direct or network connection 106. Network connections 106 can include LANs (local access networks), WANs (wide area networks), or any other suitable communication link. The invention is applicable to various types of color printing devices that make use of consumable components. Therefore, printer device 102 can include devices such as copiers, fax machines, scanners, and the like, and may also include multifunction peripheral (MFP) devices which combine the functionality of two or more peripheral devices into a single device.

In general, the host computer 104 outputs host data to the printer device 102 in a driver format suitable for the device 102, such as PCL or postscript. The printer device 102 converts the host data and outputs it onto an appropriate recording media, such as paper or transparencies.

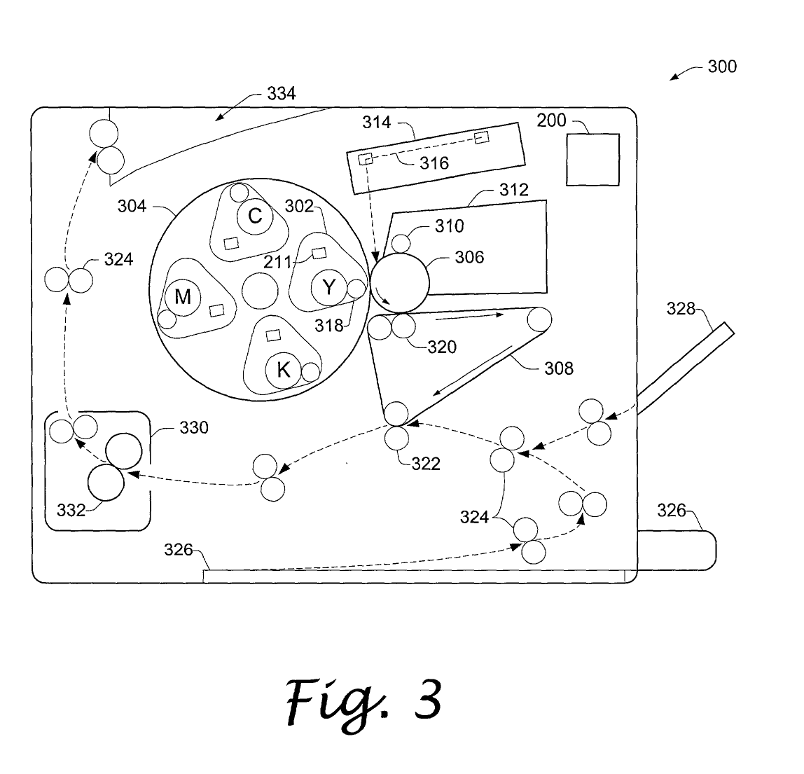

FIG. 2 illustrates the printer system 100 in more detail. The printer device 102 has a controller 200 that processes the host data. The controller 200 typically includes a data processing unit or CPU 202, a volatile memory 204 (i.e., RAM), and a non-volatile memory 206 (e.g., ROM, Flash). Printer device 102 includes a print engine 208 and one or more consumable printing components 210. Consumable(s) 210 represent print device consumables whose conditions may directly affect which colors are reproducible by the print device 102. Therefore, consumable(s) 210 generally include toner cartridges, photoconductors, and transfer drums or belts. Other consumables that do not typically affect the reproducible colors of the print device 102, such as paper and fusers, are not illustrated in FIG. 2.

Consumable(s) 210 include monitoring devices 211 located either on the print device 102 or on the consumable 210 itself. The monitoring devices 211 monitor the conditions of consumables either directly or indirectly. The information provided by a consumable monitoring device 211 allows the printer system 100 to know if certain colors are rendered non-reproducible by a non-optimal consumable condition. The printer system 100 can then respond accordingly by presenting options for managing the non-optimal condition, such as suggesting alternate color schemes to compensate for non-reproducible colors.

The controller 200 processes host data and manages the print process by controlling the print engine 208 and consumable(s) 210. Printer control logic that is typically implemented as printer driver software 212 executing on CPU(s) 202, controls the print process. The printer driver software 212 is stored in memory 206 and includes an options module that executes to receive information from the monitoring devices on the conditions of consumable(s) 210. The options module 212 presents options to the user through the host computer 104 for managing a non-optimal consumable condition. Although the printer driver software 212 and options module generally execute on print device 102, they may also be stored and execute on the host computer 104 as illustrated by printer driver 220.

The host computer 104 includes a processor 214, a volatile memory 216 (i.e., RAM), and a non-volatile memory 218 (e.g., ROM, hard disk, floppy disk, CD-ROM, etc.). The host computer 104 may be implemented, for example, as a general-purpose computer, such as a desktop personal computer, a laptop, a server, and the like. The host computer 104 may implement one or more software-based printer drivers 220 that are stored in non-volatile memory 218 and executed on the processor 214 to configure data into an appropriate format (e.g., PCL, postscript, etc.) and output the formatted data to the printer device 102.

Exemplary Print Process for Adjusting Color Gamut

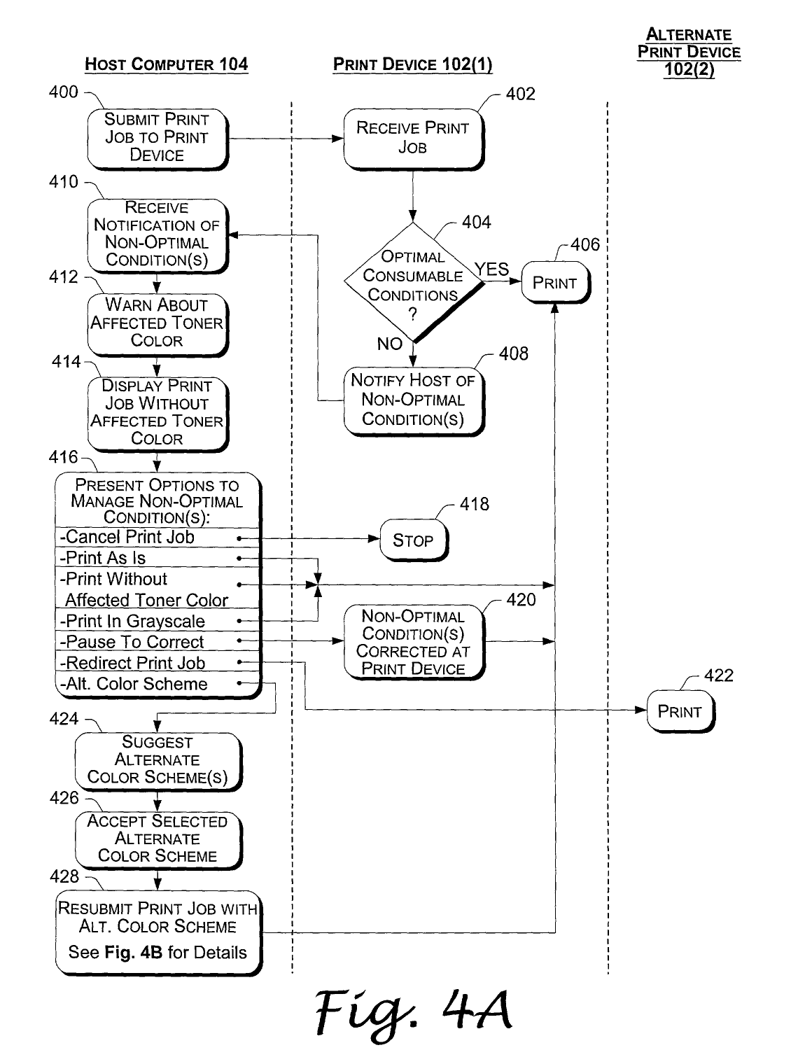

FIG. 3 represents a color laser printer 300 as an example print device 102 that may be used in the printing system 100 of FIGS. 1 and 2. A general printing process will now be described with respect to color laser printer 300 for the purpose of illustrating a context for adjusting color gamut based on the conditions of various consumable components. Consumable components whose conditions are manageable to some extent by color gamut adjustment include color toner cartridges, photoconductors, and transfer drums or belts, as generally represented in FIG. 3 by components 302, 306, and 308, respectively.

A typical color laser printer 300 produces an image using various colored toners. During an imaging process, a four color image is built sequentially onto a transfer element, such as an intermediate transfer belt (ITB) 308, before it is finally transferred to the print medium (e.g., paper, transparency) in one pass. The ultimate application of the toners to the print medium is controlled by an electrostatic imaging process.

Color printer 300 houses four toner cartridges 302 in a rotating carousel 304 that is operational with a photoconductor (OPC) drum 306. Toner cartridges 302 contain the four main toner colors cyan (C), magenta (M), yellow (Y), and black (K). Although the toner cartridges 302 are illustrated as separate devices inserted into rotating carousel 304, they may additionally be implemented as a single all-in-one color cartridge that includes the four toner colors. For example, the rotating carousel 304 may represent a single all-in-one color cartridge, while toner cartridges 302 represent separate housings within the all-in-one cartridge for accommodating the four color toners. In addition, OPC drum 306 may be implemented as one or more OPC drums. For example, there may be four OPC drums 306, one to accommodate the transfer of each color toner.

To begin the imaging process, a primary charge roller (PCR) 310 within the OPC drum assembly 312 applies an electrostatic charge to the OPC drum 306. As the OPC drum 306 rotates, a laser assembly 314 writes the latent image for the first color onto the drum 306 with laser 316. The toner carousel 304 then puts the first color toner cartridge 302 into position for operation with the OPC drum 306. Within toner cartridge 302, an agitator (not shown) guides toner to a developer roller 318. As the developer roller 318 and OPC drum 306 rotate, the toner is developed to the latent image electrostatically formed on the OPC drum 306.

Each color image is thus developed one at a time on the OPC drum 306. Also, each color image is transferred one at a time to the rotating ITB 308 because of attraction from electric charge on a primary transfer roller 320. Once the four-color image has been built on the ITB 308, the secondary transfer roller 322 is activated to attract the image away from the ITB 308 and onto the paper in one pass of the ITB 308 over the paper. The paper is guided by guide rollers 324 from a paper tray 326 or external source 328 past the ITB 308 and then through the fuser assembly 330. The fuser assembly 330 includes two hot rubber fuser rollers 332 that melt the toner, bonding it to the paper. From the fuser assembly 330, the paper then exits the printer 300 into the output tray 334.

With each page printed by the color laser printer 300, conditions of consumable components such as toner cartridges 302, OPC drums 306, and transfer belts 308 deteriorate. At some point, a non-optimal condition of a consumable will result in the inability of the printer 300 to reproduce colors that are otherwise reproducible. The printing system 100 (FIGS. 1 and 2) responds to a non-optimal consumable condition by presenting options for managing the condition, such as adjusting the color gamut.

Detecting Non-Optimal Consumable Conditions in the Print Process

Non-optimal consumable conditions can be detected in a variety of ways. For example, a monitoring device 211 on a toner cartridge 302 can directly monitor the amount of toner in the cartridge and provide information regarding toner availability to the printing system 100. Information on toner availability is sent either to the controller 200 on the printer 300 (print device 102) or to the host computer 104. In any case, printer driver software 212 (or printer driver software 220, if on host computer 104) interprets the information to control the print process. When the monitoring device 211 detects that the toner level is low or completely depleted, the options module in the printer driver software 212 executes to provide options for managing the toner condition, as discussed below.

Another way to determine the availability of toner is through an indirect measure made during a calibration cycle. At any time during the execution of a print job, the printer 300 may run a calibration cycle to ensure that each color toner 302 is transferring properly through the electrostatic imaging process. During a calibration cycle, a test patch of toner is laid down on the photoconductor drum 306 or intermediate transfer belt 308 one color at a time, and examined by a monitoring device 211. Three test patch patterns are commonly used. The first pattern is a heavy solid test patch, made up of an area completely filled with a heavy layer of toner. Another pattern is a light solid test patch, made up of an area completely filled with a light layer of toner. The last pattern often used is a series of toner lines laid down over a given area. If a toner color is empty or running low, the monitoring device 211 will provide information indicating the test patch for that particular color is not coming through as expected. Thus, the monitoring device 211 makes an indirect measure of the toner level. The monitoring device 211 signals the printing system 100 about the non-optimal condition for the toner color, and the options module in the printer driver software 212 provides options for managing the condition.

For consumables other than toner cartridges 302, such as photoconductors 306 and transfer drums or belts 308, monitoring devices can detect the conditions of the consumables by directly monitoring the effect of a step within the electrophotographic process. In an ideal process, each color toner will electrostatically charge at exactly the same level and have exactly the same charging characteristics. In reality, however, charging characteristics differ between toner colors, and the electrophotographic process is tuned so that voltage bias settings accommodate these differences. Thus, the toner color cyan (C) 302 charges “hot”, requiring a higher voltage to enable electrostatic development onto the photoconductor 306 or transfer element 308, and the toner color yellow (Y) 302 charges “cold”, requiring a lower voltage to enable electrostatic development onto the photoconductor 306 or transfer element 308. Typically, as photoconductors 306 and transfer elements 308 age, their ability to transfer “hot” charging toner colors is the first to fail.

Based on the different charging characteristics between toner colors, the charge balance present on the photoconductor 306 or transfer element 308 before and after the toner is laid down can be monitored to determine if a non-optimal consumable condition exists. The measurement of charge balance can occur during an actual printing process or during a calibration cycle. If the charge balance does not increase or decrease by the expected amount when a color toner is laid down, there is an indication that the condition of the photoconductor 306 or transfer element 308 has deteriorated to the point where that particular color toner may not be properly reproduced in the printing process. This information about the non-optimal consumable condition permits the printing system 100, through the options module in the printer driver software 212, to provide options for managing the condition.

Another way to indirectly monitor the conditions of consumables such as the photoconductor 306 and transfer element 308 involves tracking the life history of the consumable. A consumable will begin having problems transferring a particular toner color during a predictable period of the consumable's lifespan. The predictable period is determined based on known performance characteristics of the consumable type coupled with known charging characteristics of different toner colors. Therefore, a simple monitor that counts the number of rotations of a consumable can be used to provide pertinent life history information about the consumable. The life history information is an indirect measure of the consumable condition. The printing system 100 uses this information to determine when a particular color may no longer be reproducible by the print device 102. The printing system 100 can then provide options for managing the predicted non-optimal consumable condition.

Adjusting Color Gamut and Other Options for Managing Non-Optimal Consumable Conditions

When a monitoring device 211 signals the printing system 100 of a non-optimal consumable condition anytime prior to or during the execution of a print job, printer driver software executes to manage the consumable condition. As illustrated in FIGS. 2 and 3, the driver software (212 or 220) includes an options module. The driver software is either stored in and executed as part of controller 200 located on the print device 102, or it is stored in memory 218 and executed on the host computer 104.

The options module 212 (or 220) responds to a non-optimal consumable condition first, by determining what color of the four primary toner colors 302 (cyan (C), magenta (M), yellow (Y), and black (K)) is having a problem transferring through the electrophotographic print process. The non-optimal condition can be related to any print device consumable whose condition may directly affect which colors are reproducible by the print device 102, such as color toner cartridges, photoconductors, and transfer drums or belts. In addition, the non-optimal condition can be detected in various ways, including those already discussed.

After determining which of the four primary toner colors 302 is transferring improperly, the options module warns the user of the problem and provides a visual representation of the print job for display on the host computer 104. The print job is displayed without using the toner color that is not transferring properly. The options module therefore deactivates the toner color 302 affected by the non-optimal condition for purposes of displaying the non-optimal print job on the host computer 104.

The options module 212 (or 220) then provides a set of options to the user for managing the non-optimal consumable condition. These options include canceling the print job, proceeding with the print job using the non-optimal condition, deactivating the toner color affected by the non-optimal condition and proceeding with the print job, printing the print job in grayscale mode, redirecting the print job to an alternate print device, pausing the print job to permit fixing the non-optimal condition, and presenting one or more alternate color schemes to use for the print job.

The user may select from these options based on various factors such as the urgency of the print job. For example, if there is no real urgency to have the print job printed, the user may choose the option of canceling the print job, which simply stops the printing process for the current job and prepares the print device 102 for the next print job.

Selecting the option to proceed with the print job using the non-optimal condition, allows the print device 102 to output the print job even though no action has been taken to remedy the non-optimal condition. Among other things, this option may result in printed output that has streaking or fading in colors that utilize the toner color 302 being affected by the non-optimal condition. For example, if the yellow (Y) toner color 302 is being affected by the non-optimal condition, a print job that is supposed to have a green background may show a background that fades from green to cyan. This occurs because green requires a mixture of cyan (C) and yellow (Y) toners 302, and the yellow (Y) toner may be working intermittently due to the non-optimal condition.

Deactivating the toner color 302 affected by the non-optimal condition and proceeding with the print job, allows the print device 102 to output the print job without using the toner color 302 being affected by the non-optimal condition. The printed output should therefore look very similar to the visual representation of the print job being displayed on the host computer 104.

Selecting the option for grayscale mode also allows the print device 102 to output the print job without using the toner color 302 being affected by the non-optimal condition. In general, grayscale is a color mode made up of 256 shades of gray, including absolute black, absolute white, and 254 shades of gray in-between. A print device 102 converts an image having various shades of gray into a halftone image made up of purely black or white dots before printing. Therefore, printing the job in grayscale results in printed output made up of black and white dots portraying the print job in various shades of gray.

The user also has the option of redirecting the print job to an alternate print device or pausing the print job in order to fix the non-optimal condition. After the non-optimal condition is fixed, the print device 102 outputs the print job as usual.

Finally, the user has the option of selecting from one or more alternate color schemes for the print job. The options module 212 (or 220) suggests the alternate color schemes based on look-up tables stored as part of the module. The alternate color schemes are presented for viewing and selection on the host computer 104. Each look-up table corresponds to a non-optimal consumable condition affecting a particular toner color 302. Each look-up table provides one or more alternate color schemes that are the most likely acceptable alternative to the original color scheme that is no longer reproducible because of the non-optimal consumable condition. In addition, the options module 212 (or 220) and alternate color schemes in the look-up tables contemplate various other factors of the print job, such as what color text is being used.

For example, if a non-optimal condition occurs that affects the yellow (Y) toner color 302, and a print job calls for green background and black text, the options module 212 (or 220) may suggest the use of a blue background instead of green. The options module 212 (or 220) knows that blue does not require use of the yellow (Y) toner color 302. In addition, the options module contemplates that only black text is called for in the print job, and that no blue text is used. Therefore, blue may be an acceptable alternative color to use in place of green.

If the user selects an alternate color scheme for the print job, the options module 212 (or 220) maps the print job to the appropriate look-up table. Therefore, non-reproducible colors that utilize a toner color 302 affected by the non-optimal condition result in reproducible alternative colors from the look-up table. This process adjusts the color gamut of the print device 102 by adjusting the range of colors that is reproducible in printing the print job.

Exemplary Methods of Adjusting Color Gamut

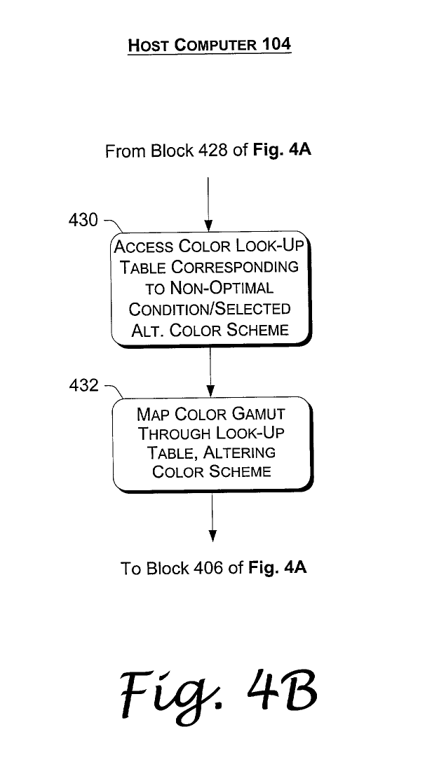

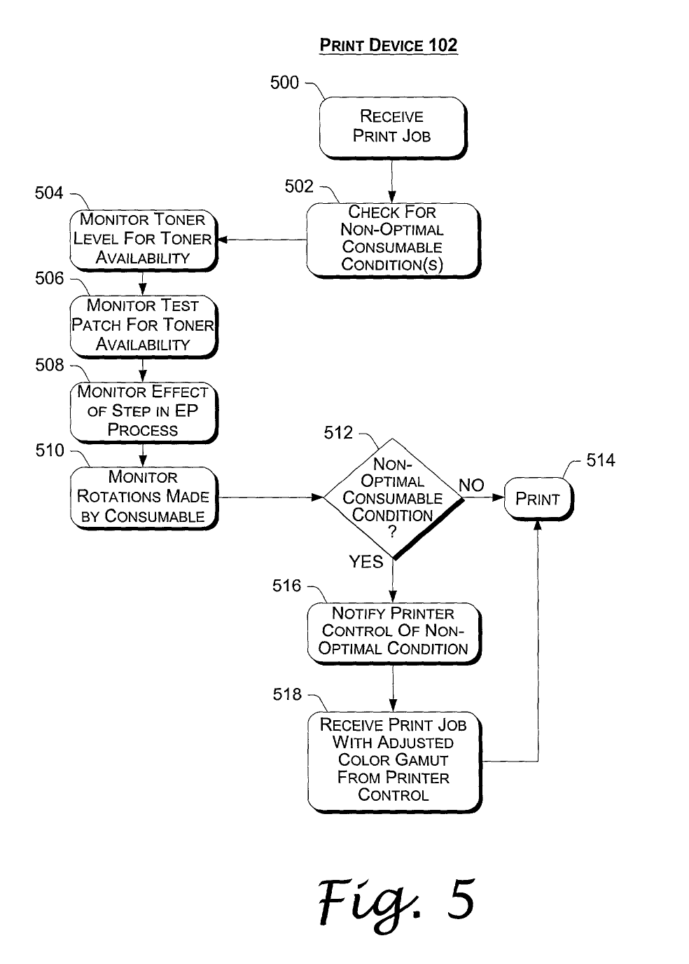

Having introduced an example system 100 in which adjusting color gamut based on consumable conditions can be implemented, methods for adjusting color gamut and otherwise managing non-optimal consumable conditions will now be described with primary reference to FIGS. 4 and 5.

FIG. 4A is a flow diagram illustrating an example method of printing in a system 100 such as that in FIGS. 1 and 2. The method of FIG. 4A includes operations that are performed alternately between a host computer 104, a print device 102(1), and an alternate print device 102(2). Although the majority of operations are shown as being implemented on the host computer 104, the control process for most of these operations can be implemented from either the host computer 104 or the print device 102(1), through printer driver software stored and executing on either machine.

The example method begins at operation 400 with the host computer 104 submitting a print job to print device 102(1). Print device 102(1) receives the print job at operation 402 and checks for non-optimal conditions in any consumable components at 404. As previously discussed, non-optimal consumable conditions involve situations such as an empty toner cartridge, a worn photoconductor, or a worn transfer element, all of which can adversely affect the transfer of a toner color through the printing process. Methods for detecting such conditions are discussed more thoroughly with respect to FIG. 5.

If consumable conditions are optimal, the print device 102(1) prints the job at operation 406. If a non-optimal condition is detected, print device 102(1) notifies the host computer 104 of the condition at operation 408. The host computer 104 receives the notification at operation 410 and displays a warning about which toner color is affected by the condition at operation 412. At operation 414, the host computer 104 displays the print job as it would appear if printed without the affected toner color.

At operation 416, options for managing the non-optimal condition are presented to the user through the host computer 104. By selecting the option of canceling the print job, the user stops the print process at operation 418. Options to print the job as is, print the job without the affected toner color, and print the job in grayscale, all result in the print device 102(1) printing the print job in the manner the option indicates at operation 406. The resulting printed output with respect to each of these options is described herein above.

The ‘pause to correct’ option at operation 416 permits the system user to correct the non-optimal condition within the print device 102(1) at operation 420, after which the print job is printed as expected at operation 406. Selecting the ‘redirect print job’ option permits the user to choose any alternate print device 102(2) appropriately coupled to the system for printing 422 the print job.

The user can further select the ‘alternate color scheme’ option at operation 416. The system, through the host computer 104, suggests alternate color schemes for the print job at operation 424 and accepts a user-selected color scheme at operation 426. The host computer 104 resubmits the print job with the alternate color scheme at operation 428, and the print job is printed at operation 406.

Details of operation 428, ‘resubmitting the print job with an alternate color scheme’, are illustrated in the continuing method shown in FIG. 4B. Resubmitting the print job with the alternate color scheme includes the process of adjusting the color gamut of the print device 102(1) with respect to the current print job. FIG. 4B illustrates the basic operations taking place when the color gamut is adjusted.

At operation 430 of FIG. 4B, a color look-up table is accessed which corresponds to the non-optimal condition and the selected alternate color scheme. The color gamut (or range of reproducible colors) of the print device 102(1) is then mapped through the color look-up table and adjusted such that the original color scheme for the print job results in the alternate color scheme. The print job is then printed with the alternate color scheme at operation 406.

FIG. 5 is a flow diagram illustrating an example method of printing where a color gamut is adjusted because of a non-optimal condition detected in a consumable component of print device 102. The method begins at operation 500 when the print device 102 receives a print job. The print device 102 has various consumable components installed whose conditions are checked at operation 502 to determine if any non-optimal conditions exist. Checking the conditions of consumable components occurs in a variety of ways, such as those illustrated in operations 504 through 510. Any or all of these methods of detecting a non-optimal consumable condition may be employed within print device 102.

At operation 504, the toner level for each toner color is monitored. If the availability of a toner color becomes a problem, the print device 102 is made aware of the non-optimal condition for that toner color. At operation 506, a toner test patch is monitored as an additional way to indicate the availability of the various toner colors.

The effect of a step in the electrophotographic process of print device 102 is monitored at operation 508. A non-optimal condition in a consumable such as a photoconductor or transfer element can be determined from an unexpected result detected in a step of the electrophotographic process. The number of rotations made by a photoconductor or transfer element is monitored in operation 510. A non-optimal condition can be presumed from the age of certain consumable components.

At operation 512, the print job is sent for printing at operation 514 when non-optimal consumable conditions have not been detected. If a non-optimal condition has been detected, the print job is not printed and the printer control is notified of the condition at operation 516. The print device 102 then receives the print job with an adjusted color gamut from the printer control at operation 518. The print job is printed using the adjusted color gamut at operation 514.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
submitting a print job to a print device;
receiving notification from the print device that a non-optimal condition exists with one or more consumables;
displaying a warning message about a toner color affected by the non-optimal condition;
displaying a visual representation of the print job without the affected toner color;
suggesting one or more alternate color schemes to use for the print job; and
if an alternate color scheme is selected, resubmitting the print job with the alternate color scheme to the print device.

2. A method as recited in claim 1, wherein resubmitting the print job further comprises:
adjusting the color gamut of the print device according to the selected alternate color scheme.

3. A method as recited in claim 2, wherein adjusting the color gamut comprises:
accessing a color look-up table that corresponds to the non-optimal condition; and
mapping the color gamut of the print device to the color look-up table to replace non-reproducible colors in the print job with reproducible colors from the look-up table according to the selected alternate color scheme.

4. A method as recited in claim 1 further comprising:
presenting print options for selection; and
executing a selected print option, the print options comprising;
canceling the print job;
permitting the print job to print with the non-optimal condition;
permitting the print job to print without the affected toner color;
redirecting the print job to an alternate print device;
pausing to permit correction of the non-optimal condition and then printing the print job; and
printing the print job in grayscale.

5. A method as recited in claim 1, wherein the non-optimal condition is a low toner level for one of a plurality of toner colors in an all-in-one toner cartridge.

6. A method as recited in claim 1, wherein the non-optimal condition is a depleted toner color for one of a plurality of toner colors in an all-in-one toner cartridge.

7. A method as recited in claim 1, wherein the non-optimal condition is a low toner level for one of a plurality of toner colors each located in a separate toner cartridge.

8. A method as recited in claim 1, wherein the non-optimal condition is a depleted toner color for one of a plurality of toner colors each located in a separate toner cartridge.

9. A method as recited in claim 1, wherein the non-optimal condition is a worn photoconductor.

10. A method as recited in claim 1, wherein the non-optimal condition is a worn transfer element.

11. Computer-readable media having computer-readable instructions for performing the method as recited in claim 1.

12. A method for adjusting a color gamut comprising:
receiving a print job from a host;
checking for a non-optimal consumable condition;
notifying the host if a non-optimal consumable condition is detected;
receiving the print job with an adjusted color gamut from the host; and
printing the print job with the adjusted color gamut.

13. A method as recited in claim 12, wherein checking for a non-optimal consumable condition further comprises:
directly monitoring toner availability by monitoring the level of toner in a toner cartridge.

14. A method as recited in claim 12, wherein checking for a non-optimal consumable condition further comprises:
indirectly monitoring toner availability by monitoring a test patch during a calibration cycle.

15. A method as recited in claim 12, wherein checking for a non-optimal consumable condition further comprises:
monitoring the effect of a step within an electrophotographic process.

16. A method as recited in claim 15, wherein the effect is the change in charge balance present on the consumable.

17. A method as recited in claim 16, wherein the consumable is a photoconductor drum.

18. A method as recited in claim 16, wherein the consumable is a transfer element.

19. A method as recited in claim 12, wherein checking for a non-optimal consumable condition further comprises:
monitoring the number of rotations made by the consumable throughout the life history of the consumable.

20. A method as recited in claim 19, wherein the consumable is a photoconductor drum.

21. A method as recited in claim 19, wherein the consumable is a transfer element.

22. Computer-readable media having computer-readable instructions for performing the method as recited in claim 12.

23. A method comprising:
receiving a print job;
checking for a non-optimal consumable condition; and
adjusting the color gamut of a print device based on a non-optimal consumable condition.

24. A method as recited in claim 23, wherein adjusting the color gamut further comprises:
accessing a color look-up table that corresponds to the non-optimal condition; and
mapping the color gamut of the print device to the color look-up table to replace non-reproducible colors in the print job with reproducible colors from the look-up table according to a selected alternate color scheme.

25. A printer comprising:
a consumable component;
a monitoring device to detect a non-optimal condition of the consumable component, the non-optimal condition affecting a toner color;
printer control logic configured to send one or more visual representations of a print job to a host computer for display, each alternate visual representation illustrating a selectable alternate color scheme that excludes the affected toner color;
the printer control logic further configured to adjust the color gamut of the printer according to a selected alternate color scheme and output the print job.

26. A printer as recited in claim 25, wherein the printer control logic is further configured to provide options for managing the non-optimal condition, the options comprising:
canceling the print job;
permitting the print job to print with the non-optimal condition;
permitting the print job to print without the affected toner color;
redirecting the print job to an alternate print device;
pausing to permit correction of the non-optimal condition and then printing the print job; and
printing the print job in grayscale.

27. A printer as recited in claim 25, wherein the consumable component is an all-in-one toner cartridge comprising a plurality of different colored toners.

28. A printer as recited in claim 25, wherein the consumable component is a plurality of consumable components and the monitoring device is a plurality of monitoring devices, each monitoring device configured to monitor the condition of one of the plurality of consumable components.

29. A computer coupled to a print device, the print device comprising a consumable component having a monitoring device configured to detect a non-optimal condition of the consumable component, the computer comprising:
a printer controller configured to send a print job to the print device;
the printer controller further configured to receive information from the monitoring device and provide options for managing a non-optimal condition, the options comprising:
canceling the print job;
permitting the print job to print with the non-optimal condition;
permitting the print job to print without a toner color affected by the non-optimal condition;
redirecting the print job to an alternate print device;
pausing the print job to permit correction of the non-optimal condition and then permitting the print job to print;
permitting the print job to print in grayscale; and
visually presenting the print job in one or more selectable alternate color schemes, each alternate color scheme excluding the toner color affected by the non-optimal condition.

30. A computer as recited in claim 29, wherein the printer controller is further configured to adjust the color gamut of the print device according to a selected alternate color scheme and resend the print job to the print device for printing.

31. A system comprising:
a monitoring device configured to monitor the condition of a consumable component;
a printer controller configured to adjust the color gamut of a print device based on a non-optimal condition of the consumable component.

32. A system as recited in claim 31, wherein the printer controller is resident in a computer.

33. A system as recited in claim 31, wherein the printer controller is resident in the print device.

34. A system comprising:
a computer;
a print device coupled to the computer, the print device comprising a consumable component;
the consumable component comprising a monitoring device configured to send information about the condition of the consumable component to the computer;
the computer configured to visually display a print job based on the condition of the consumable component;
the computer further configured to look up one or more alternate color schemes based on the condition of the consumable component and display the print job with the one or more alternate color schemes;
the computer further configured to send the print job to the print device to be printed with an alternate color scheme.
